(19) United States
(12) Patent Application Publication
(10) Pub. No.: US 2021/0084935 A1
(43) Pub. Date: Mar. 25, 2021

(54) DIETARY SUPPLEMENT SYSTEM FOR DOMESTIC PETS

(71) Applicant: Barbara L. Buchli, Littleton, CO (US)

(72) Inventor: Barbara L. Buchli, Littleton, CO (US)

(21) Appl. No.: 16/998,436

(22) Filed: Aug. 20, 2020

Related U.S. Application Data
(60) Provisional application No. 62/904,918, filed on Sep. 24, 2019.

(51) Int. Cl. A23K 10/26; A23K 50/48; A23K 10/22

(52) U.S. Cl. CPC A23K 10/26; A23K 10/22; A23K 50/48

(57) ABSTRACT

The present disclosure relates to dietary treats and supplements given to domestic pets such as cats and dogs. A dietary supplement system includes a pet treat kit with three different bottles of liquid pet treats. The three different bottles are packaged together, and each bottle provides a different size, flavor, or ingredient. The liquid pet treat is low in calories and enables the pet owner to deliver frequent, healthful treats to the pet without causing overall weight gain.

### CROSS-REFERENCE TO RELATED APPLICATION

This application claims the benefit of and priority to U.S. Provisional Patent Application Ser. No. 62/904,918, filed Sep. 24, 2019, the entire disclosure of which is incorporated by reference herein.

### BACKGROUND

The present disclosure relates to dietary treats and supplements given to domestic pets such as cats and dogs. Pet owners enjoy giving their pets dietary treats such as soft food treats, rawhide chews and twists, biscuits, dental sticks, and snacks. Treats can provide benefits including emotional wellbeing for the pets, bonding between the pet and owner, dental health, and incentive for training, education, and behavioral lessons. These benefits can lead to a safer, healthier environment for the pet and even a longer lifespan.

However, food treats given to these pets may be high in calories or may contain unhealthy ingredients that may lead to poor overall health and obesity in domestic dogs and cats. Pet obesity is an increasing problem and can shorten a pet's lifespan and quality of life, contributing to many health issues and joint problems. Rawhide chew treats in particular are very popular, but are one of the most dangerous dog treats due to the possibility of choking or material swelling inside the animal's digestive tract. Popular pet treats can include ingredients that are harmful or even toxic to pets. As an example, a partial list of ingredients that are found in some dog treats but that can be harmful to dogs (or difficult for them to digest) includes corn, wheat, soy, licorice, high amounts of sugar, sodium nitrite, artificial dyes (such as Yellow #5 and Red #40), garlic, onion, bone meal, carrageenan, high doses of vitamins, concentrated essential oils, and some preservatives (such as potassium sorbate, propylene glycol, ethoxyquin, BHA butylated hydroxyanisole, BHT butylated hydroxytoluene, TBHQ, propyl gallate, and others). Notably, pet food and treats that include meat sources such as meat “by product” or meat “digest” can come from diseased animals that have been euthanized, making these food sources unsafe for consumption.

The remainder of this disclosure is directed at systems and methods for providing healthful treats and dietary supplements to domestic pets.

### SUMMARY

The present disclosure relates to dietary treats and supplements given to domestic pets such as cats and dogs. In an embodiment, a dietary supplement system for a domestic pet includes a pet treat kit with three different bottles. The kit includes a first spray bottle capped by a removable spray nozzle, a second pour bottle capped by a removable spout, and a third travel-sized bottle capped by a removable cap. A transparent enclosure carries the first, second, and third bottles. Each bottle is filled with a liquid pet drink. The system may also include a refill container comprising an additional amount of the liquid pet drink.

### BRIEF DESCRIPTION OF THE DRAWINGS

FIG. 1 is a front view of a liquid pet treat system with five bottles, according to an embodiment of the disclosure.

FIG. 2 is a front view of a liquid pet treat system with an enclosure and refill, according to an embodiment of the disclosure.

FIG. 3 is a schematic illustration of a liquid pet treat system in two use scenarios, according to an embodiment of the disclosure.

FIG. 4 is a schematic diagram of a system for filling and packaging a line of liquid pet treats, according to an embodiment of the disclosure.

FIGS. 5A-B present front views of an interface for a mobile application for tracking pet health, according to an embodiment of the disclosure.

### DETAILED DESCRIPTION

The present disclosure relates to liquid dietary treats and supplements given to domestic pets such as cats and dogs. In an embodiment, a dietary supplement system includes a pet treat kit with three different bottles of liquid pet treats. The three different bottles are packaged together, and each bottle provides a different size, delivery mechanism (such as spray or pour spout), flavor, and/or ingredient. The liquid pet treat is low in calories and enables the pet owner to deliver frequent, healthful treats to the pet without causing overall weight gain. Multiple different lines of pet treats and supplements are provided in liquid form, for cats, dogs, or other domestic pets and in various different types of bottles and caps.

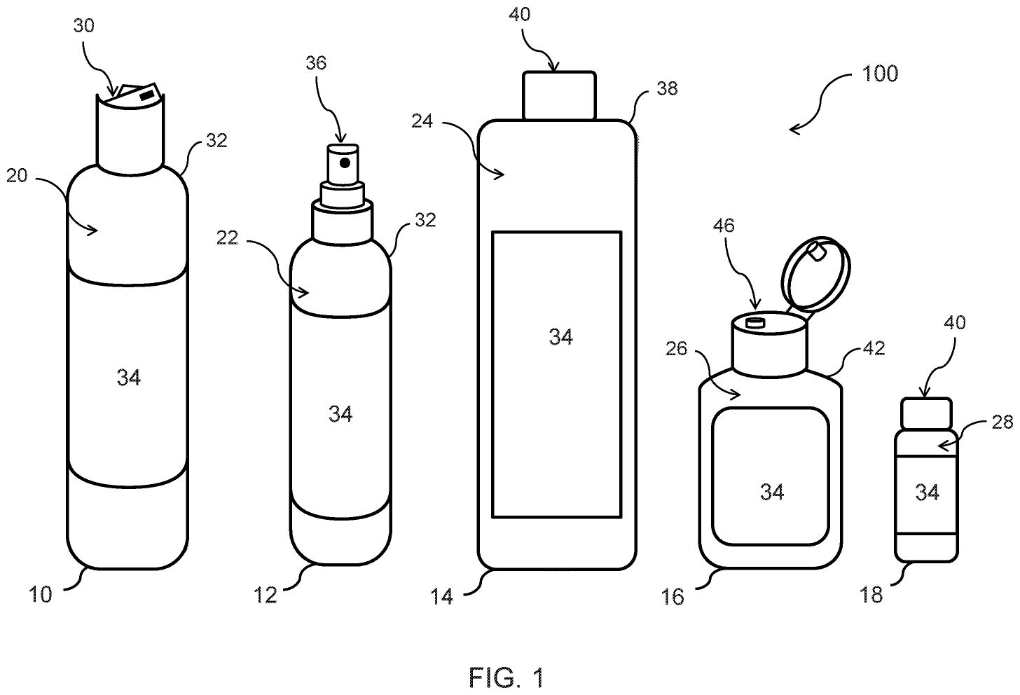

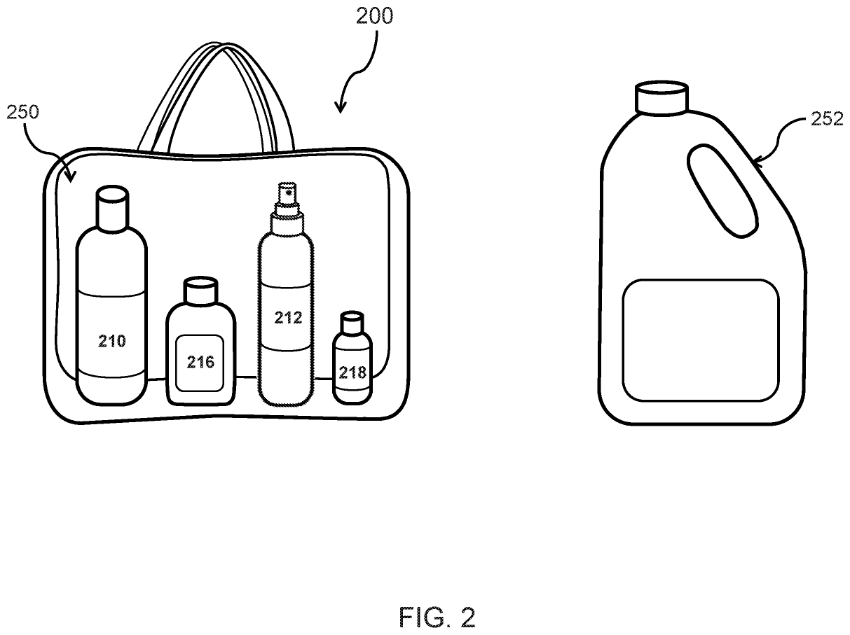

A pet treat system 100 according to an embodiment is shown in FIG. 1. The pet treat system 100 includes five different bottles—a first bottle 10, second bottle 12, third bottle 14, fourth bottle 16, and fifth bottle 18. The five bottles each have a different size and overall shape. Each bottle is filled with a liquid pet treat or pet food supplement: the first bottle 10 is filled with a first liquid 20, the second bottle 12 with a second liquid 22, the third bottle 14 with a third liquid 24, the fourth bottle 16 with a fourth liquid 26, and the fifth bottle 18 with a fifth liquid 28. These liquids may all be the same formulation (flavor, ingredients, recipe) or they may be different, or some may be the same and some different. The pet treat system 100 can include different combinations of bottles and liquid pet treats in different sizes and formulations, as described further below.

The bottles shown in FIG. 1 demonstrate a few different types of bottles that can be included in a pet treat system. The first bottle 10 has a removable flip or pour spout 30, which can be opened (such as pressing to tilt up the opening) to pour out the first liquid 20 or closed to seal it. The pour spout 30 is removable from the bottle 10 so that the bottle can be emptied and/or re-filled. The bottle 10 also includes a curved shoulder 32 with a rounded contour, curving down from the cap toward the walls of the bottle. The bottle 10 also includes a first label 34 with informational indicia about the liquid 20 inside. The bottle 10 may be transparent, semi-transparent, or opaque, and can be made from glass, plastic, or other suitable materials. In an embodiment, the material for the bottle and/or cap is recyclable.

The other bottles 12, 14, 16, 18 may have the same, similar, or different shapes and sizes than the first bottle 10. In FIG. 1, each bottle is shown with a different shape and size. The second bottle 12 is shorter and wider than the first bottle but includes the same curved shoulder 32. The second bottle 12 includes a removable spray nozzle 36, which can be pressed to actuate a spray of the liquid 22 inside the bottle 12. The third bottle 14 is taller and has a second, different shoulder 38 with a flatter curve as compared to the first shoulder 32. The third bottle also includes a removable cap 40, such as a threaded screw-cap. The fourth bottle 16 has a third shoulder 42 with a straighter taper and a label 34 that is shaped to match or mimic the third shoulder 42. The fourth bottle 16 has a flip-open cap 46. The fifth bottle 18 is a travel-sized bottle, having a miniature size (such as 1, 2, 3, or 4 ounces, or such as 3.4 ounces or less) that makes it easy to carry in a purse or bag, and suitable to pass through some security procedures. The fifth bottle 18 has a removable cap 40.

In an embodiment, the bottles have a round cosmo shape, or an oval/oblong shape with rounded shoulders. The bottles are made of a material safe for food consumption, such as glass or certain plastics (PVC, PET, styrene, polypropylene, or others).

The caps 30, 36, 40, and 46 in FIG. 1 are removable from the bottles, so that the bottles can be emptied and/or re-filled. In another embodiment, one or more bottles can have a non-removable cap, such as a non-removable pour spout. In this case, the bottle is discarded or recycled after the liquid inside is depleted. The caps for the bottles can include various types of caps such as snap top, flip top, twist top (screw-on), pour spouts, dispenser caps, pumps, sprays, and other types of caps.

A liquid pet treat system 200 according to an embodiment is shown in FIG. 2. In this embodiment, the system 200 includes an enclosure 250 and a refill bottle or jug 252 with an additional amount of the liquid pet treat (with the same formulation as the liquid in one of the bottles, or a different formulation). The enclosure 250 carries first, second, third, and fourth bottles 210, 212, 216, 218 inside the enclosure, which can be, for example, a bag, box, pouch, or similar container. The enclosure 250 can be transparent, semi-transparent, or opaque, and is optionally re-sealable. The enclosure 250 carries the bottles 210, 212, 216, 218 together in one package so that a pet owner can purchase several varieties of flavors, supplements, and/or bottle sizes all together.

In an embodiment, the bottles inside the enclosure 250 all share a characteristic, such as all being for the same type of pet (such as a dog or cat), the same size pet (such as small, medium, or large), the same flavor of treat (such as beef, chicken, fish, or others), the same diet goals (such as weight loss, anxiety and/or stress reduction, energy boosting, immunity boosting, reduction of pain and/or inflammation, and/or other goals), the same color cap (to quickly identify the flavor, goal, or pet), the same shape bottle (such as the same shoulder contour, cap type, size, or other shape), or other features. This shared characteristic enables a pet owner to purchase and easily identify the right kit for the right pet or diet goals. At the same time, the bottles inside the enclosure 250 may also each have a characteristic that differs from each other, so that each bottle serves a different purpose. For example, the bottles 210, 212, 216, 218 in FIG. 2 are each a different size (different volume). In another embodiment, the bottles each have a different type of cap (spray, pour, screw-cap, or others), or different flavors or ingredients. Thus, in some embodiment, the bottles in the enclosure 250 have some shared characteristics and some different characteristics, all in the same package.

As one example, the bottles in the enclosure 250 in FIG. 2 can all be color-coded with caps that are the same color and each bottle has a liquid treat of the same flavor or formulation. As another example, the bottles in the enclosure 250 can all be coded with caps that are different colors, and each bottle has a liquid treat of a different flavor or formulation.

In an embodiment, a first line of pet treats for dogs includes bottles that all share a visible characteristic (such as bottle or cap shape, contour, or color), and a second line of pet treats for cats includes bottles that all share a visible characteristic that is different from the first line. In another embodiment, a first line of pet treats for pet weight loss includes bottles that all share a visible characteristic (such as bottle or cap shape, contour, or color), and a second line of pet treats for anxiety and/or stress reduction (de-stress) includes bottles that all share a visible characteristic that is different from the first line. Each line of treats can have its own distinct visible characteristic that differentiates it from the other lines. Further examples include the following: a third line of pet treats for boosting energy; a fourth line of pet treats for reduction of pain and/or inflammation; a fifth line of pet treats for boosting the immune system. Further examples include: A weight loss kit for dogs comes with three bottles either 4, 6, or 8 ounces including one beef broth, one chicken broth, and one vegetable broth. A weight loss kit for cats includes three 1-ounce, 2-ounce, or 4-ounce bottles: one beef broth, one fish broth, and one chicken broth. A pet anxiety and stress reduction kit for dogs comes with three bottles either 4, 6, or 8 ounces: one beef broth, one chicken broth, and one vegetable broth. A pet anxiety reduction kit for cats includes three 4-ounce bottles: one beef broth, one fish broth, and one chicken broth. A pet pain and inflammation kit for dogs comes with three bottles either 4, 6, or 8 ounces consisting of one beef broth, one chicken broth, and one vegetable broth. A pet pain and inflammation kit for cats consists of three 1-ounce, 2-ounce, or 4-ounce bottles: one beef broth, one fish broth, and one chicken broth. A pet immune system kit for dogs comes with three bottles 4, 6, or 8 ounces consisting of one beef broth, one chicken broth, and one vegetable broth. A pet immune system kit for cats consists of three 1-ounce, 2-ounce, or 4-ounce bottles: one beef broth, one fish broth, and one chicken broth. A pet weight loss and pet anxiety and stress reduction kit includes two 4, 6, or 8 ounce bottles of beef or chicken broth for dogs, or two 1 or 3 ounce bottles of beef or chicken for cats. A pain and inflammation and immune system kit includes two 4, 6, or 8 ounce bottles of beef or chicken broth for dogs, or two 1 or 3 ounce bottles of beef or chicken for cats. It should be understood that many different combinations of bottles characteristics, colors, shapes, sizes, ingredients, flavors, and intended pets can be mixed and matched to create a pet treat system with multiple bottles packaged together.

In an embodiment, the liquid treat system 200 is designed for cats and includes bottles that mimic perfume bottles. The bottles 210, 212, 216, 218 include caps that have a metallic color such as gold or silver, with a rounded shoulder contour (such as shoulder 32 in FIG. 1). The bottles may have an etched or ribbed pattern on the sides of the bottle, or a cap that mimics the shape of a glass stopper, similar to fancy perfume bottles. A separate liquid treat system for dogs can have different physical characteristics, such as caps that are not metallic, and a more angled shoulder contour (such as the shoulder 42 in FIG. 1). These differences make the pet treats for dogs and cats easier to distinguish.

In an embodiment, the liquid pet treat system 200 includes a set of labels, such as peel-away adhesive stickers, inside the enclosure 250. The customer can use the labels to identify the bottles as desired, such as assigning them different colors or names. The labels can include various different colors, shapes, or messages, and the customer can apply these labels to the bottles to label them for a particular pet or use. The enclosure 250 can also include an optical machine-readable code, such as a barcode or QR code, for a downloadable mobile application (such as a smartphone app) for tracking pet health information, as described in further detail below.

The refill jug 252 in FIG. 2 can be provided together with the enclosure 250 or sold separately. The refill jug 252 has an additional volume of the drinkable liquid, which can be used to refill the bottles 210, 212, 216, 218 (or other bottles) after their contents are depleted. In an embodiment, the refill jug 252 is larger than the largest bottle inside the enclosure 250.

The liquid inside the bottles and refill jug is a healthful drinkable liquid that can be given to a pet as either a treat or a dietary supplement. In an embodiment, the liquid is an organic or natural broth in pet-friendly flavors. Example flavors for dogs include beef, sirloin steak, bacon, lamb, liver, chicken, turkey, vegetable, or combinations of flavors such as beef & lamb; chicken & liver; lamb & vegetable; bacon & beef. Example flavors for cats include tuna, white fish, salmon, turkey, chicken, beef, liver, lamb, sirloin steak, or a combination of flavors such as tuna & white fish; turkey & chicken; chicken & liver; steak & lamb. In an embodiment, the ingredients are organic, meaning they are free of chemical fertilizers, pesticides, artificial preservatives, artificial dyes, or other artificial agents (some examples are listed below). In an embodiment, the ingredients meet quality standards for human food consumption, such as FDA regulations for human food.

Examples of healthful drinkable liquids include: organic low-sodium or no sodium grass-fed beef broth, organic low-sodium or no sodium free-range chicken broth, organic low or no sodium vegetarian broth, organic low sodium fish broth. Ingredients may include beef stock, sirloin steak stock, liver stock, bacon stock, lamb stock, chicken stock, turkey stock, fish stock, or vegetable stock that may include celery, carrots, peas, sweet peppers, beans, zucchini, cucumbers, pumpkin, lemon, olive oil, coconut oil, echinacea, flax, aloe vera, and/or natural seasonings (basil, rosemary, coriander, turmeric, ginger, parsley).

In an embodiment, the drinkable liquid includes natural ingredients that promote a pet health goal, such as weight loss, appetite suppressant, liquid meal replacement, anxiety and stress reduction, improved energy, decreased inflammation and pain, boosted health and immune system, improved sleep, improved and balanced behavior, increased longevity, or sharper cognitive function. Example ingredients to promote one or more of these health goals may include chamomile, coconut oil, echinacea, flax, aloe vera, GABA, ginger root, the-free hemp, maca root, matcha, reishi mushrooms, L-theanine, passion flower, L-tryptophan, valerian root, low concentrations of vitamins (vitamin B6, B12, B1), phaseolus vulgaris, glutamine, L-carnitine, L-lysine, garcinia cambogia, chitosan, parsley, turmeric, spirulina, medium chain triglycerides, coconut (caprylic (C8) & capric (010) fatty acids), omega 3 oils such as eicosapentaenoic acid (EPA), omega-3's from marine forms (cold-water fatty fish like salmon, herring, sardines, and mackerel) or plant forms (Alpha-linolenic acid (ALA) derived from flaxseed, chia seed, walnuts, canola and soybean oil), Gamma-linolenic acid (GLA) from evening primrose and borage oil, Omega-6 linoleic acid from seeds and Omega 6 Arachidonic acid from meat and eggs, olive oil, amino acids, proteins, collagen, glycosaminoglycans, arginine, glutamine, proline (proteinogenic amino acid), gelatin, glucosamine, glycine, chlorophyll, and/or probiotics.

The size of the bottle varies with the size of the pet, weight loss goals (if any), the shelf-life of the ingredients in the drink, the calorie content in the drink, and the serving size. In an embodiment, the bottles range in size from 1 to 12 ounces. For example, an organic beef broth for a small dog is provided in bottles of 1 ounce for pocket or travel, 2 ounces, 4 ounces and 6 ounces, and for a large dog in bottles of 1 ounce pocket or travel, 4 ounces, 8 ounces, 12 ounces and 32 ounces. In an embodiment, the liquid drink inside the bottle is very low in calories, such that the calorie content of the entire bottle is less than 5, 10, 15, or 20 calories. In an embodiment, a single serving of the liquid drink is less than 1, 2, or 5 calories.

In an embodiment, the liquid drink is devoid of ingredients that can be harmful to pets, detrimental to health goals, or difficult to digest. For example, the liquid drink may be devoid of GMO's (genetically modified organisms), antibiotics, synthetic hormones, synthetic fertilizers, chemicals, pesticides, artificial preservatives (such as potassium sorbate, propylene glycol, ethoxyquin, BHA, BHT, TBHQ, and propyl gallate), carrageenan or cellulose for thickening agents, animal by-products, artificial or concentrated sweeteners (such as aspartame, glycerin, corn syrup, sugar, saccharin, sucralose, neotame, advantame, acesulfame potassium-k or xylitol), high doses of concentrated supplements or vitamins (such as synthetically made ascorbic acid in Vitamin C or Vitamin A), or ingredients toxic to pets such as onions, garlic, yeast, dairy, nuts, raisins, grapes, zinc, iron, chocolate, licorice, caffeine, bone meal, raw or uncooked meat or eggs, avocados, zinc, fennel, oregano, and nutmeg.

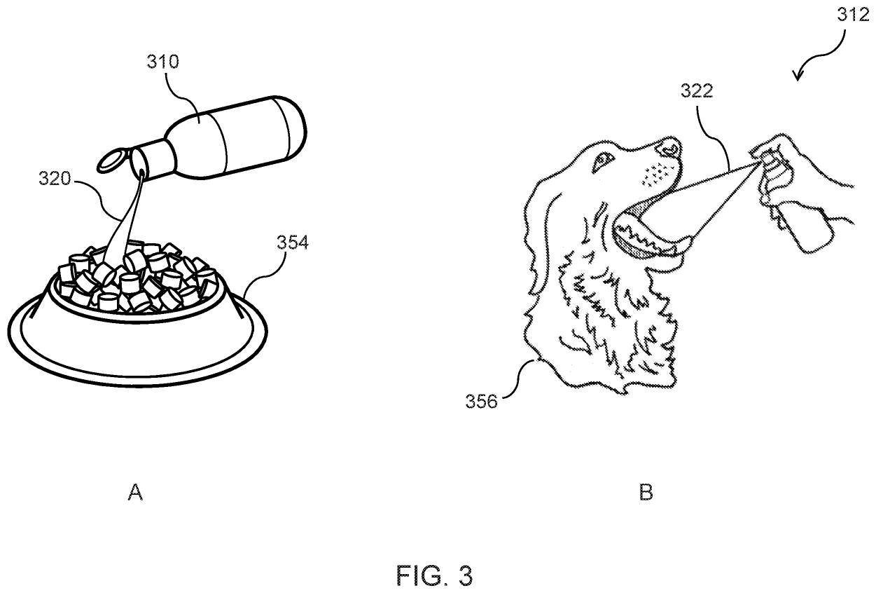

FIG. 3 shows two example uses of the liquid pet drink. Window A shows a bottle 310 that is being used to pour an amount of a first liquid 320 into a pet food bowl 354. The liquid 320 may be poured over solid food inside the pet bowl, as a flavor supplement to the solid food the pet is eating. Alternatively the liquid 320 may be given by itself in the bowl 354, without any other solid or liquid food, such as a meal replacement for a pet to promote weight loss. In window B, a spray bottle 312 is being used to deliver a spray of a second liquid 322 directly to a dog 356. In this case the liquid can be given as a treat sprayed directly into the dog's mouth.

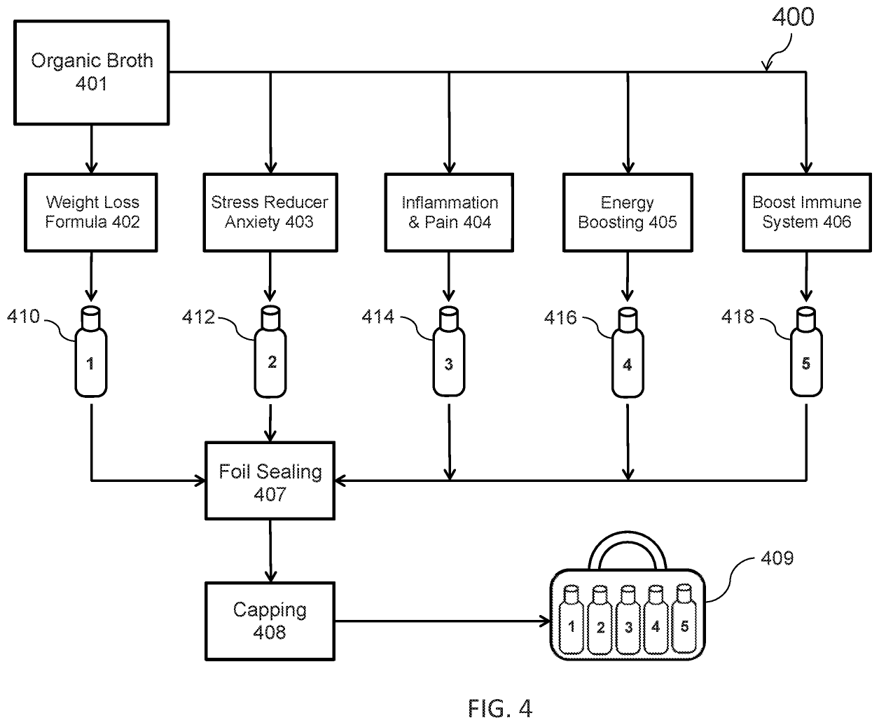

A system 400 for filling and packaging a line of liquid pet treats according to an embodiment is shown in FIG. 4. The system includes an organic broth 401, such as a beef, chicken, fish, or vegetable stock. Five different natural supplements 402, 403, 404, 405, 406 are added separately to the broth stock and then filled into five different bottles 410, 412, 414, 416, 418. The five different natural supplements may be, for example, any of the healthy ingredients listed above. In FIG. 4, they are identified as ingredients for a weight loss formula 402, stress or anxiety reducing formula 403, inflammation & pain reducing formula 404, energy boosting formula 405, and boosting immunity system formula 406. The bottles are sealed at 407, such as foil sealing, crimping, or other steps. The bottles are then capped and labeled at 408, and then packaged into an enclosure at 409. In an embodiment, the broth is a bone broth that is prepared by slow cooking organic animal bones in a pressure cooker at a low temperature for 24-48 hours. A natural acid such as apple cider vinegar or lemon juice is added to aid extraction of minerals, proteins, amino acids and nutrients from the bones. The broth is cooled to room temperature before pouring it into BPA-free bottles. The bottles are heat sealed with a non-toxic foil seal to lock out air to preserve nutrients, freshness, taste and quality. Although one broth stock and five bottles are shown in FIG. 4, more stocks and more or fewer bottles can be included in the system, to create different lines of liquid pet treats.

In an embodiment, the organic broth is made with 2 quarts of water, 7 pounds of organic bones, and 2-4 tablespoons of apple cider vinegar or lemon juice. A serving size is 1 ounce for every 10 pounds of pet body weight; for example, one serving for a 100 lb dog is 10 ounces, two servings per day. The broth can be served over food, as a meal replacement, or as a treat. Bone broth is made from natural ingredients that offer many important benefits for a pet's health. It is rich in protein, several vitamins, minerals, nutrients and amino acids such as arginine, glutamine, proline, gelatin (a breakdown of collagen), glucosamine and glycine. Even for healthy pets, bone broth is an excellent whole food multivitamin to provide a boost of nutrition to a balanced diet.

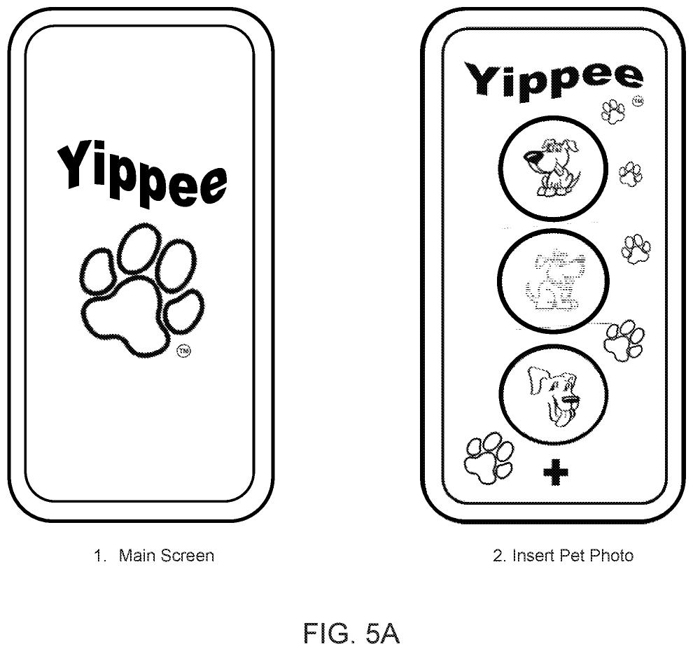

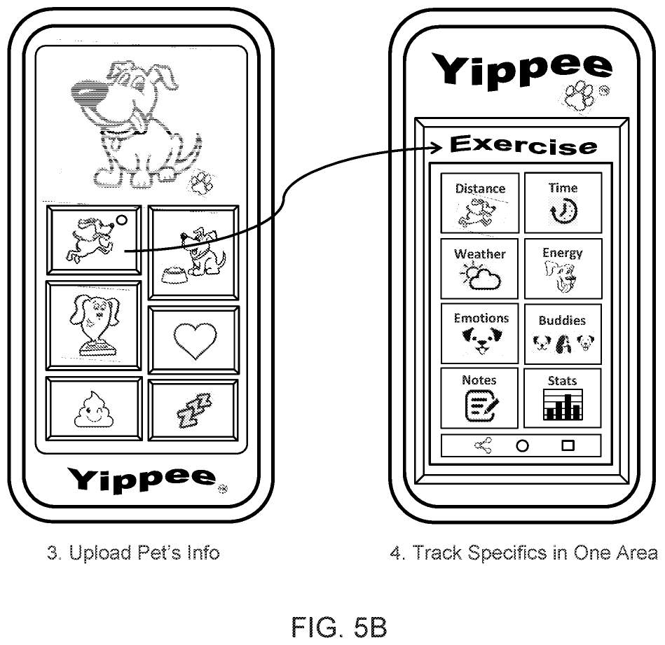

Four views of a mobile application for tracking pet health are shown in FIGS. 5A-B. Main screen #1 is a splash or loading screen that shows the brand logo and/or app name. Touch (on the touch screen or other user input such as buttons or keypads) to move to screen #2, “Insert Pet's Photo.” Touch the plus sign at the bottom of this screen to add a pet's photo, which will lead to screen #3, “Upload Pet's Information.” At this screen, the user uploads a photo of the pet and enters the pet's personal information such as weight, age, sleep habits, eating habits, stool information, emotional state, energy level, type of exercise (walk, run, sits in house, etc.), or how much attention the pet typically receives. For pets that are already entered into the app, touch that pet's photo in screen #2 to go to the pet information screen (#3).

The pet information screen (screen #3) includes several icons that each represent areas of interest. These icons can be tapped to open up a new screen with additional details about that area of interest. For example, the top-left icon (a running dog) represents exercise, and tapping it opens a new screen (screen #4, track specifics) to enter daily information about the pet's exercise. At screen #4, the user may input how long (distance) walked, the amount of time it took, weather with temperature, the pet's energy level and mood (lethargic or bouncy; depressed or elated to go for a walk; curious or uninterested), a buddy icon to enter other dogs or cats names and photos, a note icon to enter personal data, and a current status that updates overall progress and patterns.

The eating icon (shown at top right in screen #3) leads to a screen with detailed information about when the pet was fed, what food was given (including brand names of food, types of food, treats, etc), how much the pet ate each time, what time of day, the pet's emotional level and interest in eating, and other notes. In an embodiment, the app includes pre-loaded (or periodically downloaded and updated) information about the ingredients in certain recognized brands of pet food, to calculate calories, protein, fats, carbs, exposure to toxic ingredients, and other information.

Other icons shown on screen #3 represent other areas of interest. In an embodiment, the user can select which areas of interest to include in this screen. In FIG. 5B, screen #3 includes the following icons under the pet's photo (clockwise from top left): exercise (dog running), diet (dog at food bowl), pet health (heart), sleep (dog asleep), bowel movements (poop icon), and pet mental or emotional state (blue pet). Other possible areas of interest include an area for other notes, behavioral lessons, social activities, specific health goals, photos, vaccinations, or other desired information.

Based on the daily information entered by the user, the app then calculates an overall health score or health status for the pet. The app can also provide a summary of a pet's overall health habits (diet, exercise, weight), and can identify notes and patterns. The app also provides trending information to track health improvements, weight, calories, and other information to monitor improvements or declines. It will show tables of daily, weekly and monthly progress in each area to see and track any improvements or areas that need addressing. The app also recognizes patterns, such as linking sleep or activity patterns with diet, weather, exercise, weight, eating issues, or other entered information. By seeing patterns of daily habits, like what foods might trigger a pet's decline in health or emotional state, the owner could begin to make a direct connection of food, exercise, weather, or amount of attention to the pet's weight and health issues. In an embodiment, the app prompts a user to give a pet a treat, supplement, or meal based on a frequency of feeding that is suggested by the app or requested by a user.

In an embodiment, a machine-readable optical code (such as a QR code or barcode) is included with a bottle of the liquid pet treat, such as on a label on the bottle or inside an enclosure with the bottle. The QR code links to a site or service to download the mobile app shown in FIGS. 5A-B.

In an embodiment, a dietary supplement system for a domestic pet includes a pet treat kit with three bottles. The first bottle is a spray bottle capped by a removable spray nozzle. The second bottle is a pour bottle capped by a removable spout. The third bottle is a travel-sized bottle capped by a removable cap. The kit includes a transparent enclosure carrying the first, second, and third bottles. Each bottle is filled with a liquid pet drink. In an embodiment, the kid also includes a refill container comprising an additional amount of the liquid pet drink.

In an embodiment, a dietary supplement system for domestic pets includes a first line of liquid treats for a dog, a second line of liquid treats for a cat, and a third line of liquid diet supplements for a pet (such as a dog or cat). The first line includes first and second bottles packaged together in a first enclosure. The first bottle is capped by a removable spray nozzle and contains a first liquid treat with a first formulation. The second bottle is capped by a removable pour spout and contains a second liquid treat with a second formulation. Both the first and second bottles are coded by the same first color. The second line includes third and fourth bottles packaged together in a second enclosure. The third bottle contains a third liquid treat with a third formulation, and the fourth bottle contains a fourth liquid treat with a fourth formulation. Both the third and fourth bottles are coded by the same second color, such as gold or silver. The third line includes fifth and sixth bottles packaged together in a third enclosure. The fifth bottle contains a first liquid diet supplement with a fifth formulation, and the sixth bottle contains a second liquid diet supplement with a sixth formulation. Both the fifth and sixth bottles are coded by the same third color.

It should be noted that components in the figures are not necessarily to scale. Although exemplary embodiments have been described and illustrated, it should be understood that changes and modifications to these exemplary embodiments are also within the intended scope of this disclosure.

What is claimed is:

1. A dietary supplement system for a domestic pet, comprising:
a pet treat kit comprising:
a first spray bottle capped by a removable spray nozzle,
a second pour bottle capped by a removable spout,
a third travel-sized bottle capped by a removable cap, and
a transparent enclosure carrying the first, second, and third bottles,
wherein each bottle is filled with a liquid pet drink; and
a refill container comprising an additional amount of the liquid pet drink.

2. The system of claim 1, wherein the liquid pet drink in the first bottle has a first flavor, and wherein the liquid pet drink in the second bottle has a second different flavor.

3. The system of claim 1, wherein the first bottle is larger than the second bottle, and wherein the second bottle is larger than the third bottle.

4. The system of claim 1, further comprising a machine-readable optical code inside the enclosure linked to a downloadable smartphone application for tracking pet health.

5. The system of claim 1, wherein the liquid pet drink comprises an organic bone broth.

6. The system of claim 1, wherein the liquid pet drink is devoid of artificial additives.

7. The system of claim 1, further comprising a fourth bottle capped by a non-removable spout.

8. The system of claim 1, wherein the removable spout on the second pour bottle comprises a gold coating.

9. The system of claim 1, wherein the enclosure comprises a resealable bag.

10. A weight loss kit for a domestic dog, comprising:
a first bottle comprising a first liquid diet supplement comprising an appetite suppressant ingredient;
a second bottle comprising a second liquid diet supplement comprising a metabolic enhancement ingredient;
a third bottle comprising a third liquid pet supplement comprising a nutritional supplement ingredient, wherein the third liquid pet supplement is a meal replacement drink;
a fourth bottle comprising a first liquid pet treat; and
a transparent re-sealable enclosure carrying the first, second, third, and fourth bottles.

11. The weight loss kit of claim 10, wherein the fourth bottle is travel-sized and smaller than each of the first, second, and third bottles.

12. The weight loss kit of claim 10, wherein the first liquid pet treat comprises an organic beef broth.

13. A dietary supplement system for domestic pets, comprising:
a first line of liquid treats for a dog, comprising:
first and second bottles packaged together in a first enclosure,
the first bottle capped by a removable spray nozzle and comprising a first liquid treat with a first formulation,
the second bottle capped by a removable pour spout and comprising a second liquid treat with a second formulation,
wherein the first and second bottles are coded by the same first color;
a second line of liquid treats for a cat, comprising:
third and fourth bottles packaged together in a second enclosure,
the third bottle comprising a third liquid treat with a third formulation,
the fourth bottle comprising a fourth liquid treat with a fourth formulation,
wherein the third and fourth bottles are coded by the same second color, wherein the second color is gold or silver; and
a third line of liquid diet supplements for a dog, comprising:
fifth and sixth bottles packaged together in a third enclosure,
the fifth bottle comprising a first liquid diet supplement with a fifth formulation,
the sixth bottle comprising a second liquid diet supplement with a sixth formulation,
wherein the fifth and sixth bottles are coded by the same third color.

14. The system of claim 13, wherein the third and fourth formulations both include a fish flavor.
